(19) United States
(12) Patent Application Publication
(10) Pub. No.: US 2026/0101389 A1
(43) Pub. Date: Apr. 9, 2026

(54) VERIFIED PHYSICAL ACCESS OF TELECOMMUNICATIONS NETWORK SUBSCRIBERS AT THIRD-PARTY EVENTS OR VENUES

(71) Applicant: T-Mobile USA, Inc., Bellevue, WA (US)

(72) Inventor: Zoltan Homorodi, Bellevue, WA (US)

(21) Appl. No.: 18/906,982

(22) Filed: Oct. 4, 2024

(51) Int. Cl. H04W 76/11; H04W 4/80; H04W 8/18; H04W 12/06

(52) U.S. Cl. CPC H04W 76/11; H04W 4/80; H04W 8/18; H04W 12/06

(57) ABSTRACT

The verification of individuals entering controlled locations such as events and venues is improved by using wireless devices as the entry tickets themselves, verifiable by a telecommunications network. The wireless device provides a network subscriber's identification information (e.g., a phone number) to an access point terminal, in response to an identification/authentication request from the access point terminal. In order to obtain the identification information to provide to the terminal, the wireless device verifies itself via the telecommunications network, which is capable of verifying the device's subscriber identity module (SIM) via cryptographic protocols. Thus, by verifying the device's SIM, the telecommunications network verifies the identity of the network subscriber operating the device, for purposes of sharing a phone number as an entry ticket. Because entry is controlled according to the device's own network-verifiable identity, third-parties that operate events or venues need not distribute entry tickets (e.g., physical or electronic) to individuals.

### BACKGROUND

The verification of individuals entering events and venues is a critical aspect of event management and security. Traditionally, physical tickets with unique identifiers such as serial numbers or barcodes can be used to grant access. Digital ticketing systems also exist to offer enhanced security and convenience, as many individuals will remember to carry their digital devices but may forget a physical ticket slip or paper. Digital tickets, often delivered via email or mobile applications, can include features like Quick Response (QR) codes or barcodes that are scanned at entry points to verify authenticity.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an overview of an example system in which network-verifiable identities of wireless devices are used to control entry into third-party events or venues.

FIG. 4 is a sequence diagram illustrating operations for using network-verifiable identities of wireless devices to control entry into third-party events or venues.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure provides robust and secure solutions for verifying the identity of individuals entering events and venues, via their mobile network devices. By leveraging a mobile phone's identity that is linked to a network subscriber's identity—verifiable and shareable only through the subscribed network—and a secure near-field communications (NFC) handshake with access point terminals, the disclosed solutions enable authorized individuals to conveniently gain entry based on simply on the possession of their mobile network devices.

The disclosed solutions address challenges surrounding traditional systems of entry verification. Physical tickets are easily lost and left behind, while digital tickets inherently require access into an individual's device, thus presenting inconveniences and potential security concerns. Furthermore, existing systems of entry verification also may implement identity verification on top of checking tickets, implementing sophisticated systems such as Short Messaging Service (SMS) verification, biometric verification, and the like.

These existing systems are improved by the disclosed solutions, which involve using a wireless device itself as a verifiable ticket. This approach eliminates the risk of ticket loss or theft. Additionally, by using the wireless device itself as a ticket, event organizers do not need to issue physical or digital tickets to individuals, thereby streamlining the ticketing process. In some implementations, a wireless device acts as an individual's ticket based on transmitting the individual's unique identifier such as, Mobile Station International Subscriber Directory Number (MSISDN) (used by the wireless device for telecommunications services) to an access point terminal that controls entry into a location. The wireless device is configured to share the MSISDN via an NFC connection with the access point terminal, thus eliminating a need for the individual to perform an SMS authentication process to share the MSISDN with the access point terminal. The individual also need not open and access the wireless device to display entry records (e.g., barcodes, tickets, receipts), as the wireless device can interface with the access terminal via the NFC connection.

Sharing of the MSISDN is verified and guaranteed by the telecommunications network. In particular, user applications on the wireless device that interface with the access point terminal are restricted from locally retrieving and using the MSISDN for security reasons and can only obtain the MSISDN from the telecommunications network. Thus, a user application with which the access point terminal connects via NFC is configured to obtain the MSISDN from the telecommunications network following a successful verification of the device's subscriber identity module (SIM). The telecommunications network therefore verifies the individual's identity and provides the MSISDN based on verifying the device's identity.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Implementations of Wireless Communications Systems

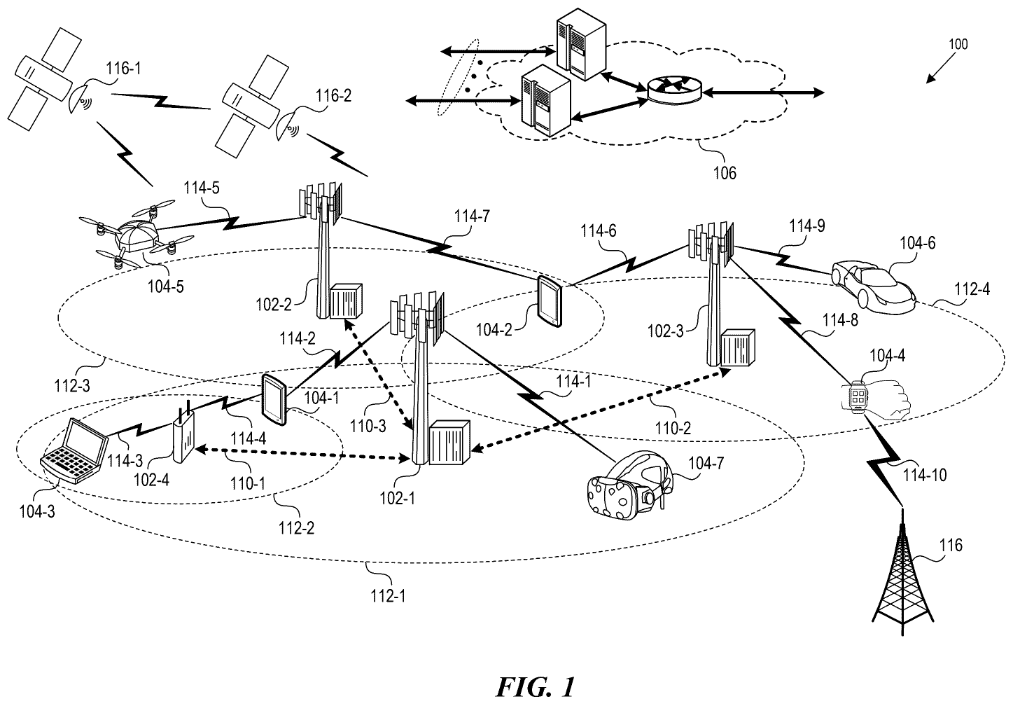

FIG. 1 is a block diagram that illustrates a wireless telecommunication network 100 (“network 100”) in which aspects of the disclosed technology are incorporated. For example, the network 100 is configured to enable RCS communication for its subscribers. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity (e.g., for RCS messaging), and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example Implementations of 5g Core Network Functions

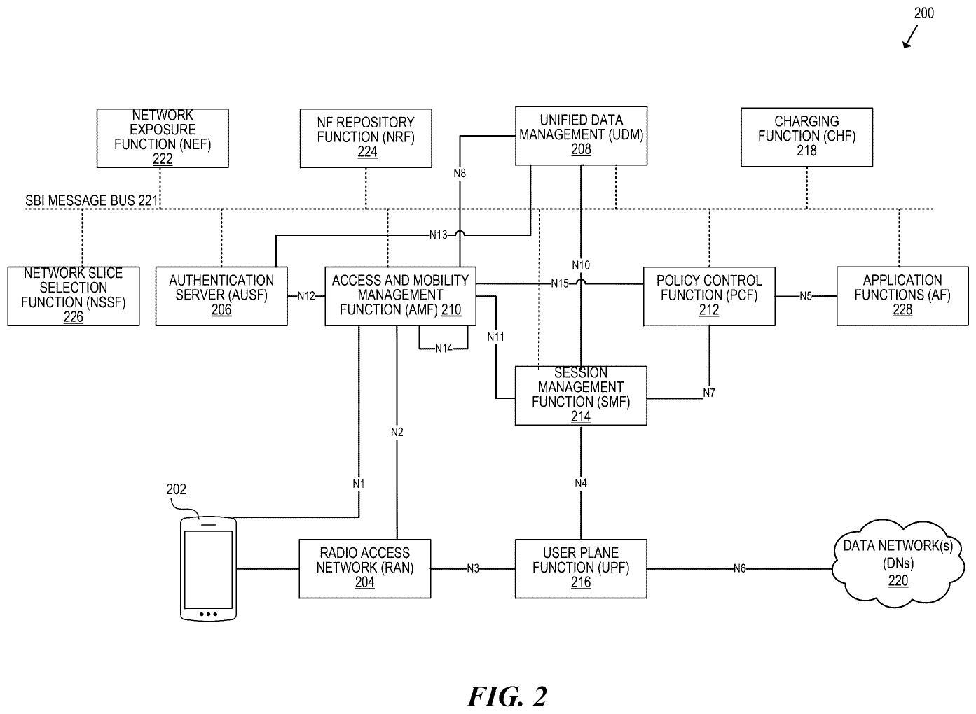

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations for Verified Physical Access of Network Subscribers

Technical solutions disclosed herein relate to controlling human entry into a location (e.g., an event venue, a retail store, a restricted area). A user's ownership of a wireless device is generally represented by the wireless device being configured with an MSISDN associated with the user. Thus, a wireless device configured with the MSISDN can act as a verified identity of the user. If the user has previously used its MSISDN to register its access or entry into a location (e.g., indicating the MSISDN when purchasing a ticket), then according to the technical solutions disclosed herein, the user can use the wireless device configured with the MSISDN to quickly and efficiently prove its access/entry registration.

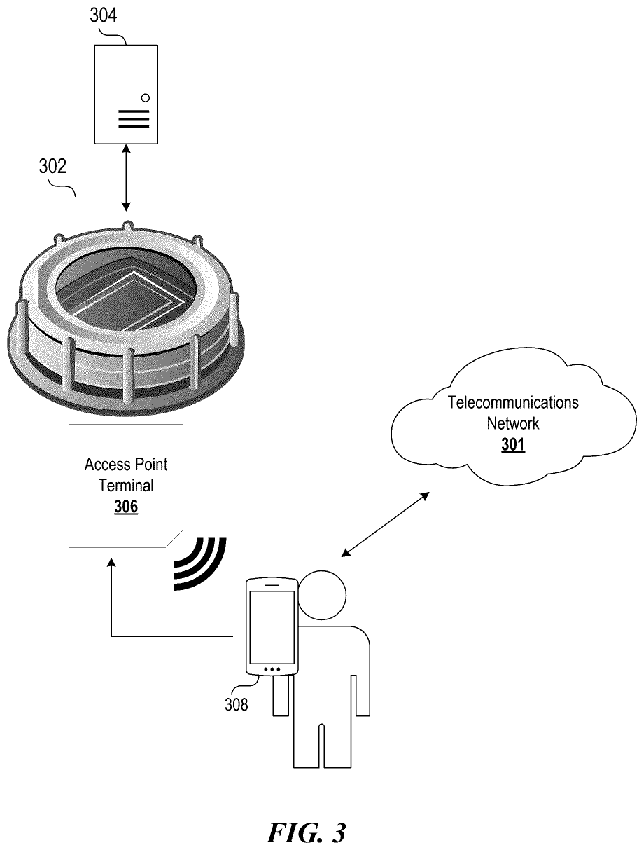

FIG. 3 illustrates an example system in which technical solutions for verifying physical access into third-party locations can be implemented. In the illustrated system, a network subscriber of a telecommunications network 301 is seeking entry into an event venue 302, which can be a location where entry is controlled by a third-party. For example, the event venue 302 can be an amusement park, a retail store, a stadium or concert venue, a conference center, a bar or nightclub, a restaurant, a government building, a school, a bank, an airport or transit hub, or the like in which the network subscriber may not be able to freely enter. In particular, the event venue 302 can generally be a location where people may need to have previously registered for entry with the third-party or approved for entry by the third-party, whether by purchasing a ticket/pass, by signing up with personal information, by being a member of a particular group, or the like. In some implementations, the event venue 302 is a location where a person's identity needs to be verified prior to the person's entry by the entity controlling the location. The third-party may be an entity hosting or producing an event at the event venue 302 (e.g., a music DJ production company), an entity that owns the event venue 302 (e.g., an owner of a football stadium, a retail operator of a retail store), an entity that manages ticketing services (e.g., Ticketmaster®, StubHub®), an entity responsibility for security at a location (e.g., government and/or military entities, security personnel), or the like.

For simplicity, certain disclosed examples may only refer to entry into the event venue 302 as a location, but it will be understood that entry to an event venue 302 generally can be time-dependent as well. For instance, a third-party may only control entry to the event venue 302 at a certain time period (e.g., when an event is happening), and an individual's access into the event venue 302 may only be valid for the certain time period.

The third-party can control entry into the event venue 302 based on maintaining records of individuals who the third-party has approved for entry into the event venue 302 (e.g., individuals who have purchased a ticket, individuals belonging to a group/class approved for entry). In the illustrated system of FIG. 3, the third-party operates a records platform 304, which can store the records of approved individuals, and one or more access point terminals 306, which access/use the records to determine whether a given individual is approved for entry into the event venue 302. These records include identification information provided by the individuals when registering for entry. For example, the individuals may provide a phone number, an e-mail address, a billing address, and/or the like when purchasing a ticket, when creating an account, and/or the like. In some implementations, the records platform 304 is a remote platform, a web platform, a cloud platform, a plurality of servers, a database, and/or the like and can store entry records for each of a plurality of events being hosted at a plurality of event venues.

In some implementations, the access point terminals 306 can be local and/or portable devices at the event venue 302 that, in response to an individual identifying themselves, consult the records platform 304 to determine whether the individual is approved for entry. For example, an access point terminal 306 is configured to transmit an identifier associated with the individual to the records platform 304 and receive a response from the records platform 304 that indicates whether the individual is authorized for entry or not. The access point terminals 306 can be located at entry points of the event venue 302, such as a gate, door, hallway, or the like. In some examples, an access point terminal 306 is a portable device such as a smartphone, a tablet, a kiosk, or the like that is configured to wirelessly communicate with the records platform 304. In such examples, the access point terminal 306 may be operated by a human operator, who may view the access point terminal 306 for a displayed indication of whether the individual is permitted to enter the event venue 302 or not. In other examples, the access point terminal 306 is configured to operate an automated barrier, such as a turnstile or gate, in order to control entry by the individual.

The third-party can implement various other configurations or techniques for the records platform 304 and the access point terminals 306 to efficiently control access into the event venue 302. For example, the access point terminals 306 may be configured to retrieve and locally store the entry records prior to an event if the number of individuals approved for entry is relatively small.

According to disclosed implementations, a network subscriber seeking entry into the event venue 302 operates a wireless device 308 that is configured to connect to the telecommunications network 301. The wireless device 308 is configured to allow the network subscriber to use the telecommunications network 301 generally based on identifying the network subscriber to the telecommunications network 301. For example, the wireless device 308 is configured with a subscriber identity module (SIM) that is configured to uniquely identify the network subscriber to the telecommunications network 301 based on an International Mobile Subscriber Identity (IMSI) that the telecommunications network 301 can authenticate (e.g., cryptographically) and associate with the subscriber's MSISDN. Therefore, the telecommunications network 301 is configured to identify the network subscriber based on identifying the wireless device 308, and the wireless device 308 is able to act as an identification for the network subscriber via the telecommunications network 301.

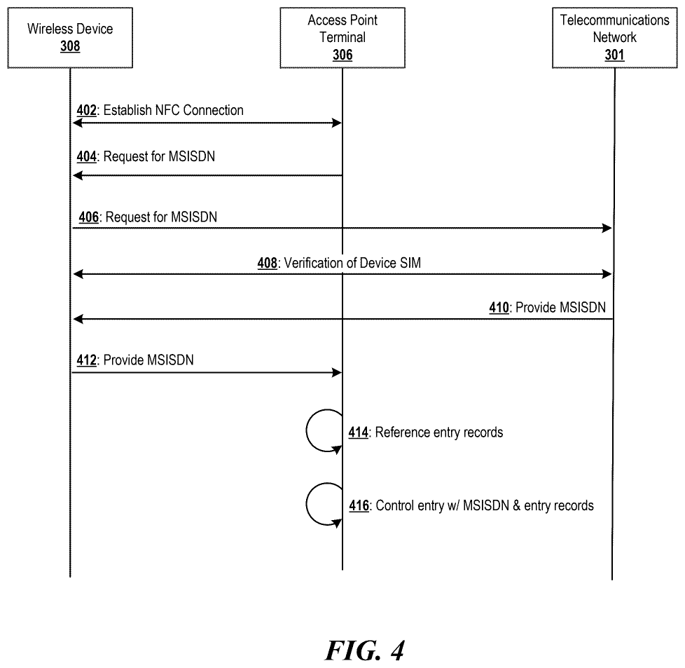

In the illustrated system of FIG. 3, the wireless device 308 acts as an identification for the network subscriber when the network subscriber requests entry into the event venue 302. The wireless device 308 is configured to establish a local or short-range connection with an access point terminal 306, such that the connection is established when the network subscriber operating (e.g., holding) the wireless device 308 is positioned near the access point terminal 306 and an entry point of the event venue 302. For example, the wireless device 308 and the access point terminal 306 are configured to establish a near-field communication (NFC) connection, a radio frequency identification (RFID) connection, a Bluetooth or Bluetooth Low Energy connection, and/or the like with one another. As disclosed in further detail with FIG. 4, the wireless device 308 can transmit messages to the access point terminal 306 that indicate the identity of the network subscriber as verified by the telecommunications network 301, and the access point terminal 306 (e.g., with the records platform 304) can permit or deny the network subscriber's entry into the event venue 302.

FIG. 4 is a sequence diagram illustrating operations in which a network subscriber uses a wireless device as a network-verified (or guaranteed) identity to request entry into a third-party location. The operations can be performed between the wireless device 308 operated by the network subscriber, an access point terminal 306, and the telecommunications network 301 within the system illustrated in FIG. 3.

At 402, the wireless device 308 and the access point terminal 306 establish a peer-to-peer connection (e.g., Bluetooth, Bluetooth Low Energy, NFC, RFID) between each other. In some implementations, the peer-to-peer connection is an NFC connection which can be established based on brief physical proximity between the device and the terminal, in contrast to other peer-to-peer connections which may require active user operation of the device to be established. This may include the network subscriber tapping the wireless device 308 on the access point terminal 306, bringing the wireless device 308 within a close range of the access point terminal 306, and/or the like. This action by the network subscriber can represent the network subscriber requesting entry into the location controlled by the access point terminal 306. For example, the network subscriber allowing the wireless device 308 to connect with the access point terminal 306 can represent and replace the network subscriber showing a physical ticket or operating the wireless device 308 to display a barcode or QR code.

In some implementations, the NFC connection with the access point terminal 306 is handled or managed by a user application on the wireless device 308 that is configured to provide network-verified or network-guaranteed identity of the network subscriber in response to a request from the access point terminal 306. In some examples, the user application is a first-party application associated with the telecommunications network 301; for example, the user application is the T-Mobile app that the network subscriber can use for managing its subscription to the T-Mobile telecommunications network. In some examples, the user application is a third-party application that is configured to perform the device's SIM validation with the telecommunications network (e.g., the third-party is permitted to request SIM validation with the telecommunications network).

In some examples, the network subscriber may not have a particular user application configured for providing network-guaranteed identity presently installed on the wireless device 308. Accordingly, in such examples, the access point terminal 306 is configured to cause installation of a lightweight temporary package, instantiation, or version of the particular user application on the wireless device 308 to facilitate the NFC connection. For example, the access point terminal 306 causes installation of an AppClip® or an Instant App for providing the network-guaranteed identity according to the operations disclosed herein, and the NFC connection is established between the AppClip® or Instant App and the access point terminal 306. The particular user application to be loaded or installed on the wireless device 308 may be identified by the wireless device via an application identifier (e.g., a uniform resource locator (URL)) that is broadcasted or communicated after the NFC connection is established.

At 404, the access point terminal 306 can request identification information associated with the network subscriber from the wireless device 308. In particular, the access terminal can request the identification information associated with the network subscriber so that the access point terminal 306 can determine (e.g., with a records platform 304) whether the network subscriber has been approved for entry. In some implementations, the access point terminal 306 requests the identification information from the user application on the wireless device 308 (e.g., a first-party application, a third-party application, a lightweight application package). In some implementations, the identification information includes existing identifiers already used in the telecommunication operation of the wireless device 308, such as an IMSI or an MSISDN. In some implementations, the identification information is artificially generated for the purposes of implementing the solutions disclosed herein. For instance, an example identification information includes a cryptographic key or identifier that would be securely generated by the telecommunication network and be independently verifiable by the access point terminal. As another example, an example identification information includes an account number, a randomly generated identifier or key, a universally unique identifier (UUID), and/or the like that the telecommunications network associates with the network subscriber.

At 406, the wireless device 308 requests the identification information from the telecommunications network 301. According to some implementations, user applications on a wireless device 308 are not permitted to freely and locally retrieve, access, or use the IMSI or MSISDN associated with the network subscriber for security and privacy reasons. Therefore, the user application on the wireless device 308 needs to obtain the identification information from the telecommunications network 301 in order to respond to the request from the access point terminal 306. Accordingly, the user application on the wireless device 308 can be configured to request the identification information from the telecommunications network 301. In some implementations, the request from the wireless device 308 may be communicated directly from the wireless device 308 to the telecommunications network 301 on the basis of the wireless device 308 being connected to the telecommunications network 301. In some implementations, the wireless device 308 may be roaming on a different telecommunications network, and the request may be forwarded to a home network for the wireless device 308, or may be handled by the roaming/visited network based on information provided prior by the home network. In some implementations, the wireless device 308 may transmit the request to the telecommunications network 301 via an Internet data connection, for example, to reach an application programming interface (API) exposed by the telecommunications network 301.

At 408, the telecommunications network 301 verifies the wireless device's identity, so that the telecommunications network 301 can provide the identification information to the user application on the wireless device 308. In particular, the telecommunications network 301 verifies the wireless device's SIM, which can then be representative of the network subscriber's identity at the wireless device. In some implementations, the telecommunications network 301 is configured to verify the wireless device's SIM based on a cryptographic protocol performed by each of the telecommunications network 301 and the wireless device 308. For example, the wireless device's SIM may implement or store a cryptographic key (e.g., a Ki) that the wireless device 308 can use to, in response to an authentication challenge sent from the telecommunications network 301, generate an authentication response to be independently (and/or asynchronously) verified by the telecommunications network 301.

Therefore, the telecommunications network 301 can perform a cryptographic protocol to determine the wireless device's SIM's identity (e.g., the IMSI). The telecommunications network 301 stores the wireless device's SIM identity in association with the MSISDN associated with the network subscriber. As such, verifying the wireless device's SIM identity allows the telecommunications network 301 to determine the MSISDN identity of the network subscriber operating the wireless device.

At 410, the telecommunications network 301 can provide the identification information of the network subscriber to the user application on the wireless device 308 after a successful verification of the wireless device's SIM identity. In some implementations, the telecommunications network 301 can further provide the identification information based on a determination that the identification information is (ultimately) shareable with the third-party associated with the access point terminal requesting the identification information. For example, telecommunications network 301 can implement a whitelist of third-parties (e.g., stored at an application function in the core network), and the request from the wireless device 308 to the telecommunications network 301 may include an identifier of the third-party (e.g., provided by the access point terminal 306). If the third party (e.g., a ticketing operator) is whitelisted by the telecommunications network, then the telecommunications network can provide the identification information (also if the SIM is successfully verified) Thus, if the whitelist includes Ticketmaster® but not Stubhub®, the telecommunications network 301 can be configured to provide the identification information to the user application if the user application is connected to a Ticketmaster® access point terminal but not if the user application is connected to a Stubhub® access point terminal.

In some implementations, the identification information includes an identifier that is the MSISDN, or is an identifier based upon the MSISDN. For example, the identifier may be a hashed identity (e.g., based on hash-based message authentication code (HMAC) SHA256), an encrypted identity, a universally unique identifier (UUID), a yes/no determination (e.g., indicating whether the user identity is verified), and/or the like, thus preserving or maintaining user privacy.

In an alternative example to 406, 408, and 410, the wireless device 308 may request MSISDN validation from the network by providing the MSISDN registered for an entry record (e.g., a mobile ticket) to the network (406). The telecommunications network 301 may then determine whether the MSISDN indicated by the wireless device 308 matches the MSISDN associated with the wireless device's (SIM) identity (408). The telecommunications network 301 may then transmit a binary indication indicating whether there is a match or not (410).

At 412, the wireless device 308 provides the identification information to the access point terminal 306 in response to the terminal's prior request. In particular, the user application on the wireless device 308 provides the identification information via the NFC connection with the access point terminal 306. In some implementations, the user application (e.g., an AppClip®, an Instant App®) may be deleted, offloaded, transitioned into an inactive or sleep state, and/or the like subsequent to its use, with respect to providing the identification information to the access point terminal 306. The removal of the user application may be configured according to a type of wireless device 308 (e.g., the original equipment manufacturer (OEM) associated with the wireless device 308); for example, certain wireless devices associated with a particular OEM may be configured to remove the user application after a certain time period (e.g., ten days, fifteen days, thirty days), while other wireless devices associated with a different OEM may remove the user application immediately, after a different time period, after a storage condition or threshold is met, and/or the like.

At 414, the access point terminal 306 references its entry records to determine whether the network subscriber should be permitted to enter the event venue. In some implementations, the access point terminal 306 checks the identification information provided from the wireless device 308 with the records platform 304.

At 416, the access point terminal 306 controls entry by the wireless device 308 into the location based on the identification information and the entry records. If the identification information appears in the entry records, the access point terminal 306 can allow entry. Otherwise, the access point terminal 306 can deny entry. In some implementations, the access point terminal 306 may control entry by displaying an indication of whether entry should be allowed or denied to a manual operator using the access point terminal 306. In some implementations, the access point terminal 306 may operate an entry mechanism, such as doors or turnstiles, to permit the network subscriber to pass through the entry into the location. In some implementations, the access point terminal 306 obtains additional entry information from the records platform 304 when checking the identification information. For example, the access point terminal 306 obtains seat location information, additional purchase information (e.g., identifying concessions pre-purchased by the individual), and/or the like, and the access point terminal 306 can display this additional information via its display.

Thus, the example operations disclosed with FIG. 4 enable an efficient and secure technique in which an individual can use their wireless device as their ticket or pass into a location. The telecommunications network to which the individual subscribes is well positioned to be a guarantor of the individual's identity based on the individual's wireless device's identity. Therefore, the telecommunications network can be configured to provide identification information for the individual to user applications on the wireless device to be shared with access point terminals.

In other implementations, the identification information can include, alternatively or additionally to the MSISDN, a network subscription level of the network subscriber. For example, a third-party may only be granting entry to T-Mobile Magenta Status subscribers, and the identification information provided by the telecommunications network (after verifying SIM identity) to the wireless device (and/or the identification information provided by the wireless device to the access point terminal) is an indication that the network subscriber is associated with T-Mobile Magenta Status. Generally, the disclosed techniques for network-guaranteed identities via wireless devices can also be applied in other settings including providing elevated/expedited service in a retail store, or checking out goods in an automated retail store.

### Example Computer Systems

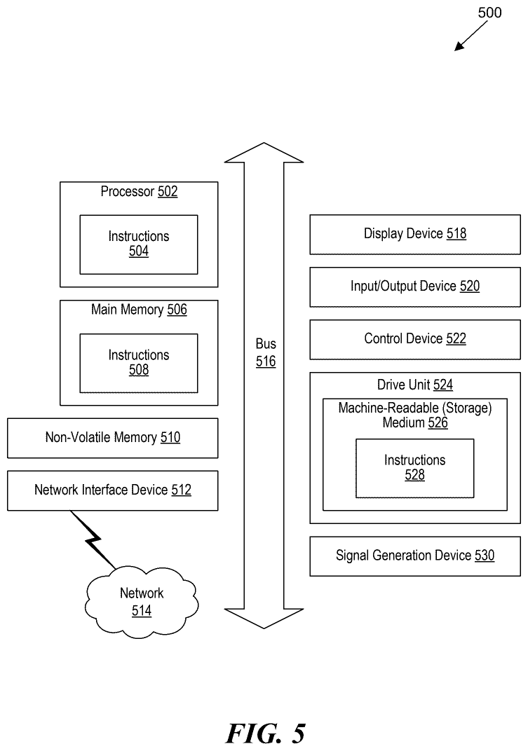

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to. ” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for. ” However, the use of the term “for” in any other context is not intended to invoke a similar interpretation. The applicant reserves the right to pursue such additional claim forms either in this application or in a continuing application.

1. A non-transitory computer-readable storage medium storing instructions that, when executed by at least one processor of a wireless device, cause the wireless device to perform operations comprising:
establishing a near-field communications (NFC) connection with an access point terminal configured to control an entry of people at a location;
receiving, via the NFC connection, a request from the access point terminal to provide identification information that is uniquely associated with a user associated with the wireless device;
transmitting a request for the identification information to a telecommunications network to which the user subscribes via the wireless device;
based on performing an asynchronous authentication handshake with the telecommunications network to verify a subscriber identity module (SIM) used by the wireless device in response to the request, receiving the identification information from the telecommunications network at the application on the wireless device; and
providing, from the application via the NFC connection, the identification information to the access point terminal, the identification information comprising an identifier previously used by the user to request an entry of the user at the location.

2. The non-transitory computer-readable storage medium of claim 1, wherein the operations further comprise:
loading the application onto the wireless device in response to the request received from the access point terminal via the NFC connection.

3. The non-transitory computer-readable storage medium of claim 2, wherein the application loaded onto the wireless device is a temporary lightweight version of a user application associated with the access point terminal.

4. The non-transitory computer-readable storage medium of claim 1, wherein the identifier included in the identification information is based on a mobile station international subscriber directory number (MSISDN) associated with the user.

5. The non-transitory computer-readable storage medium of claim 1, wherein the request transmitted to the telecommunications network identifies a ticketing operator associated with the access point terminal, and wherein the identification information is received from the telecommunications network further based on the ticketing operator being whitelisted for identifying users subscribed to the telecommunications network.

6. A method for authentication via near-field communications connections, comprising:
establishing a near-field communications (NFC) connection between an application on a wireless device and an access point terminal associated with controlling an entry of device users at a location;
receiving, at the wireless device via the NFC connection, a request from the access point terminal to provide an identifier previously provided by a user of the wireless device for an authenticated entry into the location;
in accordance with the identifier being inaccessible by the application, obtaining, at the wireless device, the identifier from a telecommunications network to which the user subscribes via the wireless device; and
providing the identifier to the access point terminal from the application loaded on the wireless device via the NFC connection to allow the authenticated entry of the user at the location.

7. The method of claim 6, wherein the identifier is obtained at the wireless device subsequent to an asynchronous SIM authentication being performed between the telecommunications network and the wireless device.

8. The method of claim 6, further comprising:
loading the application onto the wireless device in response to the request from the access point terminal being received.

9. The method of claim 6, wherein the application is an App Clip® or an Android® Instant App.

10. The method of claim 6, wherein the identifier provided to the access point terminal is based upon a MSISDN associated with the user.

11. The method of claim 6, wherein the identifier is obtained from the telecommunications network in response to identifying, to the telecommunications network, an operator associated with the access point terminal.

12. The method of claim 6, further comprising:
providing, prior to the NFC connection being established, the identifier to a remote platform associated with the access point terminal to register the authenticated entry of the user at the location.

13. A system for authentication, comprising:
at least one hardware processor; and
at least one hardware memory storing instructions that, when executed by the at least one hardware processor, cause the system to perform operations comprising:
establishing a near-field communications (NFC) connection between an application on a wireless device and a third-party terminal;
receiving, via the NFC connection, a request from the third-party terminal to provide identification information associated with a user of the wireless device;
obtaining, at the wireless device, the identification information from a telecommunications network to which the user subscribes via the wireless device; and
providing the identification information to the third-party terminal from the application loaded on the wireless device via the NFC connection.

14. The system of claim 13, wherein the request from the third-party terminal for the identification information is received in connection with the user of the wireless device requesting an entry at a location controlled by the third-party terminal.

15. The system of claim 13, wherein the identification information is obtained at the wireless device subsequent to an asynchronous SIM authentication being performed between the telecommunications network and the wireless device.

16. The system of claim 13, wherein the operations further comprise:
loading the application onto the wireless device in response to the request from the third-party terminal being received.

17. The system of claim 16, wherein the application loaded onto the wireless device is a temporary instantiation of a user application associated with the third-party terminal.

18. The system of claim 13, wherein the identification information is obtained from the telecommunications network based on the identification information that is requested by the third-party terminal comprising an identifier based upon a MSISDN that is inaccessible by the application loaded on the wireless device.

19. The system of claim 13, wherein the identification information is obtained from the telecommunications network in response to identifying, to the telecommunications network, an operator associated with the third-party terminal.

20. The system of claim 13, further comprising:
providing, prior to the NFC connection being established, the identification information to a remote platform associated with the third-party terminal to enable the third-party terminal to process the identification information provided via the NFC connection.
